(19) United States
(12) Patent Application Publication
(10) Pub. No.: US 2012/0247563 A1
(43) Pub. Date: Oct. 4, 2012

(54) Water conservation apparatus and methods of using same

(76) Inventor: Hein Werner Erdmann, Sarasota, FL (US)

(21) Appl. No.: 13/064,610

(22) Filed: Apr. 4, 2011

(51) Int. Cl. F03B 11/02

(52) U.S. Cl. 137/1; 137/561 R

(57) ABSTRACT

Disclosed herein are water conservation methods and apparatuses that comprise optionally directing drainage water from a sink by a valve to either a toilet storage tank or the sewer or septic system. The drainage water diverted to the toilet storage tank can then be recycled by being used to flush the toilet. The valve may be easily manipulated by a user to provide a convenient option to recycle water for flushing the toilet, a use that is currently a major factor in the overconsumption of water in a household.

### FIELD OF THE INVENTION

The present invention relates to water conservation methods and a water conservation apparatus which may optionally direct drainage water from a sink to a toilet storage tank or the sewer or septic system. The water directed to the toilet storage tank can then be recycled and further utilized to flush the toilet. Depending on the user's needs or preferences, the water conservation method and apparatus may comprise a valve that may be easily manipulated by a user to direct sink drainage water to either the toilet storage tank or the sewer system—such as diverting contaminated water to the sewer system, but diverting suitable water to the toilet storage tank.

### BACKGROUND OF THE INVENTION

Green technology is an expanding industry that is embraced by consumers and the business community to find alternative means to lower consumption of natural resources. An important natural resource, water, is only increasing in demand due to among other things, the increasing world population. Indeed, the world's population tripled in the 20th century, and it is estimated that the world population will increase by another 40 to 50% in the next fifty years. The exploding population growth has also been coupled with industrialization and urbanization. Both factors have provided an increasing demand for natural resources such as water in urbanized and dense population areas. As access to water and water resources continue to dwindle, the need to lower consumption of water continues to rise. The access to and need for clean water is not isolated to non-U.S. countries. The demand for water in the U.S. is also an increasing problem. In 1990, for example, 30 states in the U.S. reported “water-stress” conditions. In 2000, the number of states reporting water-stress rose to 40 and in 2009, the number of states reporting water-stress rose again rose to 45. There is thus a worsening trend in water supply and access throughout the world, including within the U.S.

One of the largest uses of water in a household is toilet flushing. For example, 75% of water used indoors is in the bathroom, and 25% of this is for the toilet. The amount of water used in one toilet flush depends on the toilet and when the toilet was made, but can range from about 1.6 gallons to over 4 gallons of water (toilets from the 1980's are using about 3.5 gallons of water per flush). Even the current low consumption toilets use 1.6 gallons of clean water per flush. Thus, the overuse of toilet flushing of clean water continues to be a major factor in the overconsumption of water. To assist with this problem, it would be beneficial to develop more efficient ways to consume water and specifically, for the purpose of flushing toilets. Other systems for saving water, for example as in United States Pat. No. 5,573,677, relate to recovery systems of cloudy water from a washing machine to be recycled for use in flushing toilets. The apparatus in U.S. Pat. No. 5,573,677, however, is limited to recovering water from washing machines and does not provide the user with an option or convenience to divert the water either to the sewer or the toilet storage tank when desired. Further, it would be particularly convenient to provide inexpensive ways to save water in the household that would not require costly installation or parts. Indeed, for cost-sensitive consumers not solely concerned about the environment, an incentive to save money on their monthly water bill may be removed if any water conservations methods or apparatuses are excessively inconvenient or expensive to install. Therefore, convenient and cost effective methods and apparatuses to save on household consumption of water, including from various household appliances, could provide distinct advantages in the green technology field.

### SUMMARY OF THE INVENTION

The present invention addresses problems of the prior art by providing a convenient water conservation method and apparatus that allows a user to optionally direct drainage water from a sink to one or more toilet storage tanks and/or a sewer or septic system. The drainage water directed to a toilet storage tank can then be recycled by being used to flush the toilet. In one embodiment of the present invention, the methods and apparatus for conserving water may comprise directing drainage water from at least one sink by a valve to a toilet storage outlet pipe or a sewage outlet pipe; directing drainage water directed to the toilet storage outlet pipe to at least one toilet storage tank; storing the drainage water in at least one toilet storage tank; directing the drainage water stored in the toilet storage tank to an outlet pipe through a toilet; and directing the drainage water directed to the sewage outlet pipe to a sewer or septic system. In a specific embodiment, the methods and apparatus may additionally comprise directing the drainage water from the toilet storage outlet pipe to a water storage compartment before being directed to the toilet storage tank.

In another embodiment, the methods and apparatus of the present invention may comprise a valve, wherein the valve is a two-way valve thereby directing the drainage water to either the sewer or septic system or the toilet storage tank. In another embodiment, the valve is electronically or mechanically activated to direct water either to the toilet storage outlet pipe or the sewage outlet pipe. In another embodiment, the valve is activated to direct drainage water to the toilet storage tank until the toilet storage tank is filled. In another embodiment of the methods and apparatus, the valve is activated to direct drainage water to the toilet storage tank once the toilet storage tank is emptied.

In another specific embodiment, the methods and apparatus of the present invention may comprise a valve that is inserted into the drainage hole of the sink and into the pipe fitting, wherein the pipe fitting is attached to the bottom of the sink and encompasses the bottom of the sink drainage hole. In another embodiment, the pipe fitting may be connected to the sewage water outlet pipe and connected to the toilet storage outlet pipe.

In another specific embodiment of the present invention, the methods and apparatus may comprise a valve that comprises a first end, a second end, an actuator, a plurality of transverse O-rings, an inlet for drainage water, an outlet for drainage water, and two longitudinal side sealers; wherein the actuator may be located at the first end, the inlet may be proximal to the first end, a first transverse O-ring may be located between the actuator and the inlet, the outlet may be proximal to the second end, a second transverse O-ring may be located between the inlet and the outlet, a third transverse O-ring may be located at the second end, and the longitudinal side sealers may be located 180 degrees from each other. In one embodiment, the valve may comprise three transverse O-rings. In another embodiment, the valve may be rotated 180 degrees inside the pipe fitting by, for example, twisting the actuator, thereby providing one position that directs drainage water to the toilet storage outlet pipe and wherein a second position may be set after the 180 degree rotation and directs drainage water to the sewage outlet pipe. In another embodiment, the valve inserted in the pipe fitting may be lifted vertically up in an up position and pushed vertically down in a down position, wherein the down position plugs the sink and the up position allows water to drain down the sink. In another embodiment, the valve may be removable from the drainage hole of the sink and the pipe fitting.

In another specific embodiment, the methods and apparatus of the present invention may comprise a sewage water outlet pipe and a toilet storage outlet pipe made of one or more base materials, for example, selected from one or more of PVC, CPVC, copper, steel, brass, other form of plastic or metal, or a combination thereof. In a specific embodiment, the sewage water outlet pipe and/or toilet storage outlet pipe may comprise PVC.

In another specific embodiment, the methods and apparatus of the present invention may comprise a pipe fitting that comprises four arms. In another specific embodiment, one arm may be connected to the sink and may be a water inlet, one arm may be a water outlet connected to the sewage water outlet pipe, one arm may be a water outlet connected to the toilet storage outlet pipe and one arm may be sealed.

In another embodiment, the present invention may include apparatuses for conserving water that may correspond to and be utilized with the methods directly above. In a specific embodiment of the present invention, an apparatus may comprise a sink, a valve, a pipe fitting, a sewage water outlet pipe, a toilet storage outlet pipe, a toilet and a toilet storage tank, wherein the pipe fitting may be connected to the drainage hole of the sink, the valve may be inserted within the drainage hole of the sink and the pipe fitting; wherein the pipe fitting may be directly connected to both the sewage water outlet pipe and the toilet storage outlet pipe, wherein the toilet storage outlet pipe may also connected to the toilet storage tank of the toilet and the sewage water outlet pipe may also be connected to a sewer or septic system; wherein the valve directs sink drainage water to the toilet storage outlet pipe or the sewage outlet pipe.

In another embodiment of the present invention, the apparatus may comprise a cylindrical valve, wherein the cylindrical valve may comprise a first end, a second end, an actuator, a plurality of transverse O-rings, an inlet for drainage water, an outlet for drainage water, and two longitudinal side sealers; wherein the actuator may be located at the first end, the inlet may be proximal to the first end, a first transverse O-ring may be between the actuator and the inlet, the outlet may be proximal to the second end, a second transverse O-ring may be between the inlet and the outlet, a third transverse O-ring may be located at the second end, and the longitudinal side sealers may be located 180 degrees from each other. In another embodiment, the valve may be inserted into a pipe fitting, wherein the pipe fitting comprises four arms. In a specific embodiment, one arm of the pipe fitting may be connected to the sink and may be a water inlet, one arm may be a water outlet connected to the sewage outlet pipe, one arm may be a water outlet connected to the toilet storage outlet pipe and one arm may be sealed. In a specific embodiment, the valve may be inserted into the arm connected to the sink.

In another embodiment of the present invention, the valve of the apparatus may be rotated 180 degrees inside the pipe fitting by the actuator, thereby providing one position that directs drainage water to the toilet storage outlet pipe and wherein a second position may be set after the 180 degree rotation and directs drainage water to the sewage outlet pipe. In another embodiment, the valve inserted in the pipefitting may be lifted vertically up in an up position and pushed vertically down in a down position, wherein the down position plugs the sink and the up position allows water to drain down the sink. In another specific embodiment, the valve may be removable from the drainage hole of the sink and/or the pipe fitting.

### BRIEF DESCRIPTION OF THE FIGURES

FIG. 1 is a diagram of a water conversation apparatus that contains a toilet and a sink where the drain from the sink is connected to a pipe fitting with an inserted valve that allows the sink drainage water to be optionally diverted to the toilet storage tank or the sewer line/septic tank line.

FIG. 2 is a diagram of the pipe fitting connected to the bottom of sink and encompasses the drain of the sink. A valve is inserted into both the drainage hole of the sink and the pipe fitting, where the pipe fitting may provide access to a toilet storage outlet pipe and a sewage outlet pipe.

FIGS. 3a and 3b are diagrams of the side view and corresponding cross section view respectfully of a valve that can be inserted into the drain of a sink and a connected pipe fitting.

FIGS. 3c and 3d are diagrams of the side view and corresponding cross section view respectfully of the valve rotated 90 degrees relative to FIGS. 3a and 3b.

FIG. 4 is a diagram of a pipe fitting that may be connected to the drain of the sink and may be connected to a toilet storage outlet pipe and a sewer outlet pipe.

### DETAILED DESCRIPTION OF THE INVENTION

It is understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a sink” is a reference to one or more sinks and includes equivalents thereof known to those skilled in the art and so forth.

Unless defined otherwise, all technical and scientific terms used herein have the same meanings as commonly understood by one of ordinary skill in the art to which this invention belongs. Specific methods, devices, and materials are described, although any methods and materials similar or equivalent to those described herein can be used in the practice or testing of the present invention.

“Actuator” is defined as and without limitation, a mechanical device for moving or controlling a mechanism or system. An actuator, without limitation, can therefore comprise a dial, a rotating dial, a knob, a lever, etc. An actuator may also comprise a mechanism that moves or controls a system due to an electric current, hydraulic fluid pressure or pneumatic pressure or other mechanical means.

“Pipe fitting” herein is defined as and without limitation, a system of pipes or tubing that comprise at least one inlet and at least one outlet and may be further connected to joints/pipes or other devices to transfer water to a particular destination.

“Sewage outlet pipe” herein is defined as and without limitation, a pipe that directs drainage water to a sewer system or septic tank system or the like.

“Toilet storage outlet pipe” herein is defined as and without limitation, a pipe that directs drainage water to a path that ultimately goes through a toilet. The drainage water can go directly to a toilet or can for example, be stored in a toilet storage tank, water storage compartment, other water storage device, or a combination thereof, before passing through a toilet.

The present invention relates to a method and apparatus for conserving water. Specifically, the present invention provides a method and apparatus to optionally divert drainage water from household use to a toilet storage tank as opposed to the sewer line or septic tank line, thereby allowing the drainage water to be recycled and used to flush a toilet. In one specific embodiment, the methods and apparatuses may optionally direct drainage water from a sink by a valve to a toilet storage outlet pipe or a sewage outlet pipe. The drainage water diverted to the toilet storage outlet pipe is then directed to at least one toilet storage tank, wherein the drainage water can be recycled by flushing at least one toilet using the drainage water from the toilet storage tank. If desired, the drainage water can still be diverted to the sewer or septic system by optionally directing the drainage water to the sewage outlet pipe.

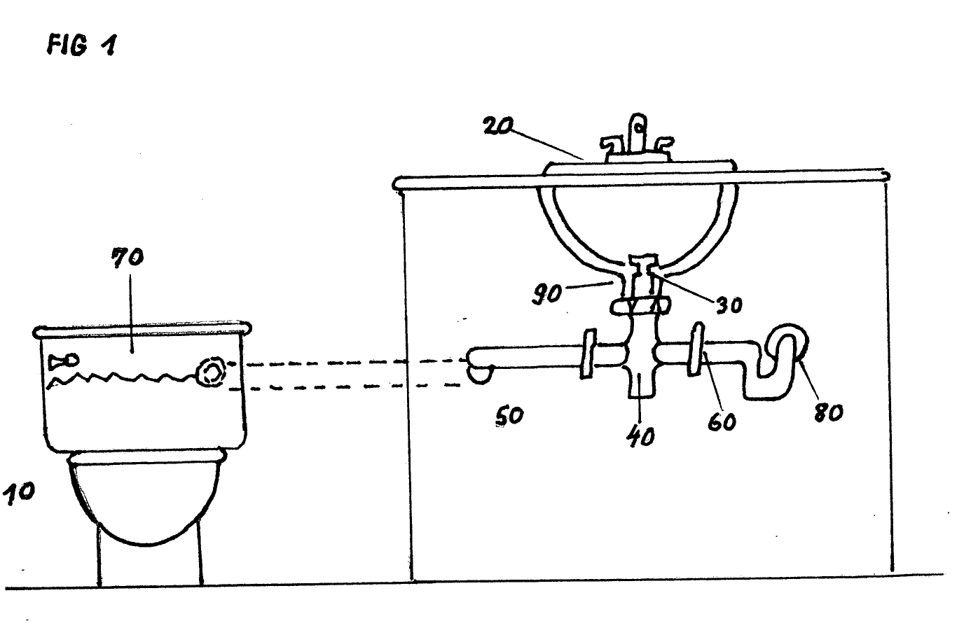

Turning to the Figures, FIG. 1 depicts one embodiment of a water conservation apparatus of the present invention that is in fluid communication with a toilet 10 and a sink 20 where the drain from the sink 30 is connected to a pipe fitting 40 that is also connected to two horizontal pipes, (a toilet storage outlet pipe 50 and a sewage outlet pipe 60) which lead to the toilet storage tank 70 or the sewer line/septic tank line 80 respectively. Drainage water from the sink 20 may be diverted to either the toilet storage outlet pipe 50 or the sewage outlet pipe 60 by the use of a valve 90. In one embodiment, the valve 90 may be inserted into the drainage hole of the sink 30 and inserted into the pipe fitting 40 which may be connected to the bottom of the sink 20, just below the sink drainage hole 30. The valve 90 may be placed into position to direct the sink drainage water either to the sewage outlet pipe 60 or the toilet storage outlet pipe 50. In one position, the valve may be rotated in a static pipe fitting 40 to direct the sink drainage water to the sewage outlet pipe 60. Optionally, the valve 90 may be rotated 180 degrees in a static pipe fitting 40 to direct the sink drainage water to the toilet storage outlet pipe 50.

FIG. 1 depicts one embodiment of a water conservation apparatus of the present invention that is in fluid communication with one sink and one toilet. The water conservation apparatus, however, is not limited solely to a one sink/one toilet system. For example, in one embodiment, twin sinks may be used. In another embodiment, three or more sinks may be used in the water conservation method or apparatus. In another embodiment, the system may include more than one toilet from different bathrooms. In another embodiment, the drainage water diverted to the toilet storage outlet pipe may then be stored in a water storage compartment before being diverted to the toilet storage tank (e.g., a tank located on back of the toilet). In this embodiment, the water storage compartment may hold a larger amount of drainage water that can then, for example, be diverted to one or more toilet storage tanks when needed. In another embodiment, the water storage compartment may be mechanically or electrically activated to divert water to a toilet storage tank. In a specific embodiment, the water storage compartment is activated to convey drainage water to toilet storage tank until the toilet storage tank is filled. In another specific embodiment, the storage compartment is activated to convey drainage water to toilet storage tank once the toilet storage tank is emptied.

In another embodiment of the present invention, the valve may be electronically or mechanically activated to direct water either to the toilet storage outlet pipe or the sewage outlet pipe. In a specific embodiment, the valve may be activated to direct drainage water to the toilet storage tank until the toilet storage tank is filled. In another embodiment, the valve may be activated to direct drainage water to the toilet storage tank once the toilet storage tank is emptied.

In another specific embodiment, the valve 90 may be located in the drainage hole of the sink 30 and inserted into the pipe fitting 40 and may be activated to convey drainage water directly to either the toilet storage outlet pipe 50 or the sewage outlet pipe 60. In another embodiment, the valve 90 may simply comprise an actuator for easy manipulation by a user to divert the sink drainage water to either the toilet storage outlet pipe 50 or the sewage outlet pipe 60. In another embodiment, the valve may direct drainage two or more locations., i.e., a two-way valve. In another embodiment, the valve may be a three-way valve. In another embodiment, the valve may be a four-way or more valve.

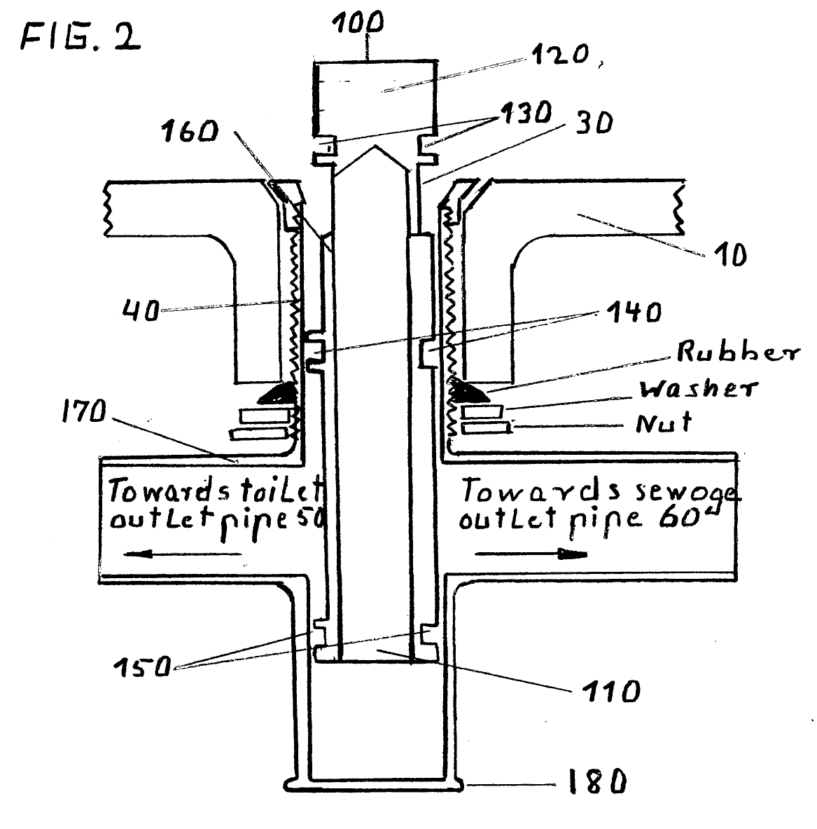

FIG. 2 depicts a specific embodiment of a two-way valve 90 inserted into the drainage hole of the sink 30 and in the pipe fitting 40. As depicted, the valve may be cylindrical and comprise a first end 100, a second end 110, an actuator 120, three transverse O-rings that encircle the valve (130, 140 and 150), an inlet for drainage water 160 and an outlet for drainage water 170. As depicted in FIG. 2, the actuator 120 may be located at the first end 100 of the valve and an inlet for sink drainage water 160 may be located proximal to the first end 100 of the valve. A first transverse O-ring 130, may be located between the actuator 120 and the inlet 160. The outlet 170 may be located proximal to the second end 110, and the second transverse O-ring 140 may be located between the inlet 160 and the outlet 170. The third transverse O-ring 150 may be located at the second end 120.

As depicted in FIG. 2, the valve 90 may be positioned in the drainage hole of the sink 30 and in the pipe fitting 40 to direct sink drainage water to the toilet storage outlet pipe 50. Water flowing from the faucet of the sink 20 flows down the drainage hole of the sink 30 and into the pipe fitting 40 wherein the water may be diverted into the inlet 160 of the valve. The drainage water flows into the cylinder of the valve 90 by gravity flow and out the outlet 170 of the valve into the pipe fitting 30, wherein the water may be directed to the toilet storage outlet pipe 50. In the depicted position of the apparatus of FIG. 2, the inlet 160 and outlet 170 are facing towards the toilet storage outlet pipe 50.

In another embodiment, the actuator 120 of the valve 90 may be rotated 180 degrees, thereby rotating the valve 180 degrees and positioning the inlet 160 and outlet 170 to face towards the sewage outlet pipe 60 and thus away from the toilet storage outlet pipe 50. In this position, water flowing from the faucet of the sink 20 flows down the drainage hole of the sink 30 and into the pipe fitting 40 wherein the water may be diverted into the inlet 160 of the valve 90. The drainage water flows into the cylinder of the valve 90 by gravity flow and out the outlet 170 of the valve into the pipe fitting 30, wherein the water may be directed to the sewage outlet pipe 60.

Further, to assure that drainage water that flows down into the drainage hole of the sink 30 and pipe fitting 30 may be directed only to the inlet 160 of the valve, a second transverse O-ring 140 may be placed on the valve between the inlet 160 and the outlet 170. The second transverse O-ring 140 thus seals the interface of the outside of the valve 90 with the inside of the pipe fitting 30, assuring that no drainage water drains down the pipefitting other than thru the inlet 160 of the valve. Accordingly, drainage water may be directed only to the toilet storage outlet pipe 50 or to the sewage outlet pipe 60 for each particular position of the valve 90.

In another embodiment, the valve 90 may be vertically moved up and down inside the pipe fitting 30. In another specific embodiment, the valve 90 may be pushed vertically down to plug the sink 20 or pulled vertically up to allow the sink drainage water to flow into the sink drain 30 and pipe fitting 40 and inlet 160 of the valve. This feature is also depicted in FIG. 2. In the depicted position, the valve 90 may be in an up position thereby allowing water from the sink 20 to drain. The valve 90 may then be pushed vertically down until the second end of the valve 110 touches the bottom of the pipe fitting 180. At this position, the first transverse O-ring 130 contacts the inside edges of the pipe fitting 40, thereby providing a seal at its interface with the sink drain 30 and plugging the sink 20.

Further, a third transverse O-ring 150 may be placed at the second end of the valve 110 thereby providing a seal so no drainage water seeps passed the second end of the valve 110. This feature, for example, allows the valve to easily slide up and down for the user to easily plug and unplug the sink drain when desired. In another embodiment, the valve 90 may be easily pulled entirely out from the pipefitting 40 and sink 20 for convenient cleaning.

In a specific embodiment of the present invention, the actuator 120 may be rotated by the hand of a user. In a specific embodiment of the present invention, the actuator 120 may be rotated by a mechanical or electrical means, such as by an electric motor. In another specific embodiment, the methods and apparatuses of the present invention may include an actuator that by a mechanical or electrical means, opens the inlet and outlet of the valve. In another specific embodiment, an outlet in the valve may be facing both the toilet storage outlet pipe and the sewage outlet pipe. Accordingly, an actuator by mechanical or electrical means opens an inlet only for the specific outlet pipe. In this design, no rotation of the valve would be necessary.

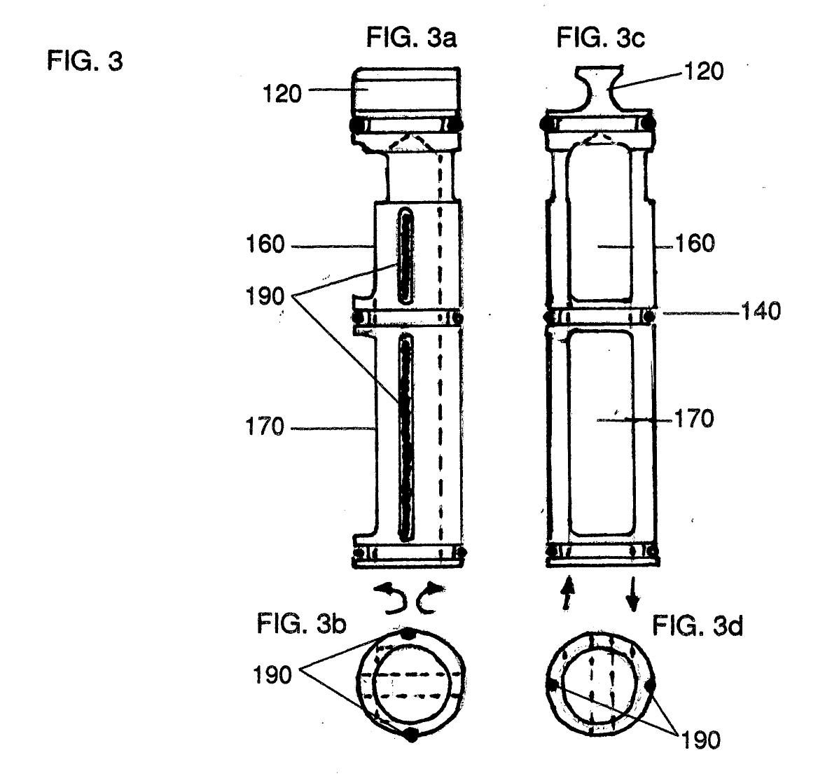

In another embodiment of the present invention, the valve 90 may comprise longitudinal side sealers 200. In a specific embodiment, longitudinal side sealers 200 may be placed on opposite sides, 180 degrees from each other, on the valve 90. In another embodiment, the longitudinal side sealers 200 may be located approximately 90 degrees from the inlet 160 and the outlet 170 of the valve. Such a feature is depicted in FIGS. 3a-3d. FIGS. 3a and 3b depict a side view and corresponding cross section view of the valve 90. FIGS. 3c and 3d are also the side view and corresponding cross section view of the valve 90, but rotated 90 degrees relative to FIGS. 3a and 3b. FIGS. 3a-3d depict the longitudinal side sealers 200 on opposite sides of the valve 90 and approximately 90 degrees from the inlet 160 and outlet 170 of the valve, thereby providing a longitudinal seal between the interface of the valve and the pipe fitting. Further, the longitudinal side sealers 200 provide easier rotation of the valve 90 by twisting the actuator 120 to the desired position of the valve 90.

Regarding other described features of specific embodiments of the valve 90, FIG. 3a shows the side view of the valve as in the position in FIG. 2. FIG. 3b shows the cross sectional view in the same position. FIG. 3c shows a front view of the inlet 160 and outlet 170. As depicted, drainage water can flow into the inlet 160, and out the outlet 170, wherein the second transverse O-ring 140 seals the interface between the inside of the pipefitting 40 and the outside of the of the valve 90. In another embodiment, the valve may be made of one or more base materials. For example, the valve may comprise one or more of PVC, CPVC, copper, steel, brass, other form of plastic or metal, or a combination thereof. Further, specific parts of the valve may comprise various base materials. For example, in a specific embodiment of the present invention, the transverse O-rings and longitudinal side sealers may comprise rubber.

In another embodiment, the pipe fitting may be comprise one or more base materials. For example, the pipe fitting may comprise PVC, CPVC, copper, steel, brass, other form of plastic or metal, or a combination thereof. In a specific embodiment, the pipe fitting may comprise brass. In another embodiment, the pipe fitting may be connected to a sewage outlet pipe and a toilet storage outlet pipe comprising one or more base materials. For example, the outlet pipes may comprise PVC, CPVC, copper, steel, brass, other form of plastic or metal, or a combination thereof. In a specific embodiment, the outlet pipes may comprise PVC. In another embodiment, the pipefitting may be connected to the outlet pipes by the use of a joint. In another specific embodiment, the pipe pitting may be connected to the bottom of the sink, thereby encompassing the bottom of the sink drainage hole.

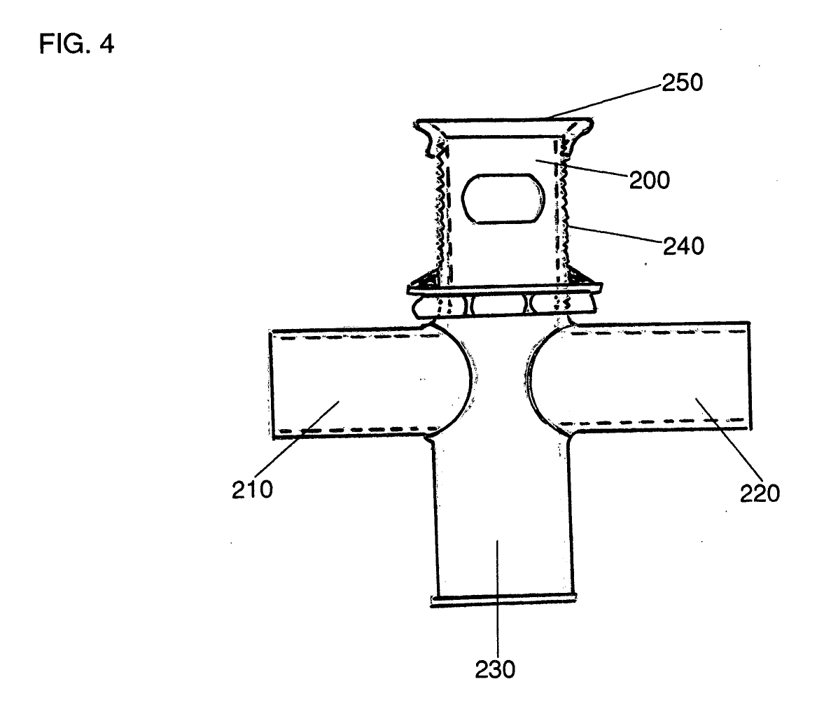

FIG. 2 is a diagram of a pipe fitting that may be connected to the bottom of the sink and which may encompass the bottom of the sink drainage hole. Further, the pipe fitting may comprise arms that are connected to a toilet storage outlet pipe and a sewage/septic tank outlet pipe. In another embodiment, the pipe fitting may be elbow shaped. In another specific embodiment, the pipe fitting may be Tee-shaped. In another embodiment, the pipe fitting may be cross shaped. In another embodiment, the pipe fitting may comprise one inlet. In another embodiment, the pipe fitting may comprise two inlets. In another embodiment, the pipe fitting may comprise three or more inlets. In another embodiment, the pipe fitting may comprise one outlet. In another embodiment, the pipe fitting may comprise two outlets. In another embodiment, the pipe fitting may comprise three or more outlets. In another embodiment, the pipe fitting may comprise one arm. In another embodiment, the pipe fitting may comprise two arms. In another embodiment, the pipe fitting may comprise three arms. In another embodiment, the pipe fitting may comprise four or more arms. In another embodiment, the pipe fitting may comprise threaded arms. In a specific embodiment, the pipe fitting may comprise one inlet, and two outlets. In another embodiment, the pipe fitting may comprise one inlet, two outlets and have four arms. Such a configuration is depicted in FIG. 4. The pipe fitting 40 comprises four arms, wherein the top arm 200 comprises a water inlet, the left arm 210 and right arm 220 comprise water outlets, and the bottom arm 230 is sealed at the end. In another specific embodiment, the top arm 200 may be connected to the sink 20. In a specific embodiment, the top arm 200 may comprise various means to attach to the bottom of the sink 20. In a specific embodiment, the top arm 200 may be threaded 240. In another embodiment, the top arm may be attached to a threaded washer 250 to provide a seal and/or connection to the sink. In another embodiment, the pipe fitting may be connected to the sink by another joint. In another example, the pipe fitting may be connected or tightened by the use of one or more nuts, bolts or screws. In a specific embodiment, the pipe fitting may be connected by a brass nut.

While specific embodiments of the present invention have been described, other and further modifications and changes may be made without departing from the spirit of the invention. All further and other modifications and changes are included that come within the scope of the invention as set forth in the claims. The disclosures of all publications cited above are expressly incorporated by reference in their entireties to the same extent as if each were incorporated by reference individually.

What is claimed is:

1. A method for conserving water comprising:
directing drainage water from at least one sink by a valve to a toilet storage outlet pipe or a sewage outlet pipe;
directing said drainage water directed to said toilet storage outlet pipe to at least one toilet storage tank;
storing said drainage water in at least one said toilet storage tank;
directing said drainage water stored in said toilet storage tank to an outlet pipe through a toilet; and
directing said drainage water directed to said sewage outlet pipe to a sewer or septic system.

2. The method of claim 1, wherein said method additionally comprises directing said drainage water from said toilet storage outlet pipe to a water storage compartment before being directed to said toilet storage tank.

3. The method of claim 1 wherein said valve is a two-way valve, thereby directing said drainage water to either said sewer or septic system or said toilet storage tank.

4. The method of claim 3, wherein said valve is electronically or mechanically activated to direct water either to said toilet storage outlet pipe or said sewage outlet pipe.

5. The method of claim 4, wherein said valve is activated to direct drainage water to said toilet storage tank until said toilet storage tank is filled.

6. The method of claim 4, wherein said valve is activated to direct drainage water to said toilet storage tank once said toilet storage tank is emptied.

7. The method of claim 1, wherein said valve is inserted into a drainage hole of said sink and into a pipe fitting, wherein said pipe fitting is attached to the bottom of the sink and encompasses the bottom of said sink drainage hole.

8. The method of claim 7, wherein said pipe fitting is also connected to said sewage outlet pipe and connected to said toilet storage outlet pipe.

9. The method of claim 7, wherein said valve comprises a first end, a second end, an actuator, three transverse O-rings, an inlet for drainage water, an outlet for drainage water, and two longitudinal side sealers;
wherein said actuator is located at said first end, said inlet is proximal to said first end, a first transverse O-ring is located between said actuator and said inlet, said outlet is proximal to said second end, a second transverse O-ring is located between said inlet and said outlet, a third transverse O-ring is located at said second end, and said longitudinal side sealers are located 180 degrees from each other.

10. The method of claim 9, wherein said valve is rotated 180 degrees inside said pipe fitting by said actuator, thereby providing one position that directs drainage water to said toilet storage outlet pipe and wherein a second position is set after the 180 degree rotation and directs drainage water to said sewage outlet pipe.

11. The method of claim 9, wherein said valve inserted in said pipe fitting is lifted vertically up in an up position and pushed vertically down in a down position,
wherein said down position plugs said sink and said up position allows water to drain down said sink.

12. The method of claim 9, wherein said valve is removable from said drainage hole of said sink and said pipe fitting.

13. The method of claim 1, wherein the sewage outlet pipe and the toilet storage outlet pipe comprises PVC.

14. The method of claim 7, wherein said pipe fitting comprises four arms.

15. The method of claim 14, wherein one arm is connected to said sink and is a water inlet, one arm is a water outlet connected to said sewage water outlet pipe, one arm is a water outlet connected to said toilet storage outlet pipe and one arm is sealed.

16. An apparatus comprising at least one sink, a valve, a pipe fitting, a sewage outlet pipe, a toilet storage outlet pipe, a toilet and a toilet storage tank, wherein said pipe fitting is connected to the drainage hole of said sink, said valve is inserted within the drainage hole of said sink and said pipe fitting;
wherein said pipe fitting is directly connected to both the sewage outlet pipe, and said toilet storage outlet pipe; and wherein said toilet storage outlet pipe is also connected to said toilet storage tank of said toilet and the sewage outlet pipe is also connected to a sewer or septic system, wherein said valve optionally directs sink drainage water to said toilet storage outlet pipe or said sewage outlet pipe.

17. An apparatus comprising a cylindrical valve, wherein said cylindrical valve comprises a first end, a second end, an actuator, three transverse O-rings, an inlet for drainage water, an outlet for drainage water, and two longitudinal side sealers;
wherein said actuator is located at said first end, said inlet is proximal to said first end, a first transverse O-ring is between said actuator and said inlet, said outlet is proximal to said second end, a second transverse O-ring is between said inlet and said outlet, a third transverse O-ring is located at said second end, and said longitudinal side sealers are located 180 degrees from each other.

18. The apparatus of claim 17, wherein said valve is inserted into a pipe fitting, wherein said pipe fitting comprises four arms.

19. The apparatus of claim 18, wherein one arm is connected to a sink and is a water inlet, one arm is a water outlet connected to a sewage water outlet pipe, one arm is a water outlet connected to a toilet storage outlet pipe and one arm is sealed.

20. The apparatus of claim 19, wherein said valve is inserted into said arm connected to said sink.

21. The apparatus of claim 19, wherein said valve is rotated 180 degrees inside said pipe fitting by said actuator, thereby providing one position that directs drainage water to said toilet storage outlet pipe and wherein a second position is set after the 180 degree rotation and directs drainage water to said sewage outlet pipe.

22. The apparatus of claim 19, wherein said valve inserted in said pipe fitting is lifted vertically up in an up position and pushed vertically down in a down position,
wherein said down position plugs said sink and said up position allows water to drain down said sink.

23. The apparatus of claim 20, wherein said valve is removable from said drainage hole of said sink and said pipe fitting.
